(19) United States
(12) Patent Application Publication
(10) Pub. No.: US 2006/0070499 A1
(43) Pub. Date: Apr. 6, 2006

(54) Power handle and method of using same

(76) Inventor: Martin S. Brooks, Hagaman, NY (US)

Correspondence Address: DELAIN LAW OFFICE, PLLC, 400 CLIFTON CORPORATE PARKWAY, CLIFTON PARK, NY, 12065, US

(21) Appl. No.: 11/243,213

(22) Filed: Oct. 4, 2005

Related U.S. Application Data
(60) Provisional application No. 60/615,318, filed on Oct. 4, 2004.

(51) Int. Cl. B25B 23/16

(52) U.S. Cl. 81/177.2; 81/184

(57) ABSTRACT

An apparatus and method for analyzing selection criteria for increasing torque for wrenches and pliers. The apparatus includes an elongated strip having a first end, a second end and a longitudinal axis there between, wherein the first end has a cylindrically shaped handle and the second end has a channeled groove, wherein the cylindrically shaped handle and the channeled groove are coplanar with the strip and lie along the longitudinal axis of the strip, and wherein the strip has an opening between the handle and the channeled groove. In another embodiment, the apparatus includes an elongated rod having a first end, a second end and a longitudinal axis there between, wherein the first end is a female fitting for a standard ratchet wrench and the second end is a male end of a standard ratchet wrench; and a handle operably coupled to the elongated rod.

The present patent application is a non-provisional application claiming priority from a provisional application with Ser. No. 60/615,318 (filed Oct. 4, 2004 and entitled (“Power Handle”).

### FIELD OF USE

The present invention relates generally to a handle of a tool and method for using the handle and more particularly to a power or extension handle for increasing torque applied to a tool operably coupled to the handle and a method for using the power or extension handle.

### BACKGROUND

Many tools such as ratchet wrenches, crescent wrenches, pliers and the like operate by gripping a non-circular nut or head of a bolt to fasten a plurality of objects together. The wrenches or pliers fasten the plurality of objects by exerting a torque or turning or twisting force to move the head of the bolt and nut in opposite directions.

There is a need for an improved handle and method of using the improved handle for increasing the torque that may be applied to a head of a bolt or a nut.

### SUMMARY OF THE INVENTION

A first aspect of the present invention provides a power or extension handle, comprising: an elongated strip having a first end, a second end and a longitudinal axis there between, wherein the first end has a cylindrically shaped handle and the second end has a channeled groove, wherein the cylindrically shaped handle and the channeled groove are coplanar with the strip and lie along the longitudinal axis of the strip, and wherein the strip has an opening between the handle and the channeled groove.

A second aspect of the present invention provides a power or extension handle, comprising: an elongated rod having a first end, a second end and a longitudinal axis there between, wherein the first end is a female fitting for a standard ratchet wrench and the second end is a male end of a standard ratchet wrench; and a handle operably coupled to the elongated rod so that an angle formed by the elongated rod and the handle is from about 0 to about 175 degrees.

A third aspect of the present invention provides a method of using a power or extension handle, comprising: providing an elongated rod having first end, a second end and a longitudinal axis there between, wherein the first end is a female fitting for a standard ratchet wrench and the second end is a male end of a standard ratchet wrench; providing a handle operably coupled to the elongated rod so that an angle formed by the elongated rod and the handle is from about 0 to about 175 degrees; and providing a ratchet wrench, wherein the ratchet in inserted into the female end of the rod.

### BRIEF DESCRIPTION OF THE FIGURES

FIG. 1 depicts an elevation view of the power or extension handle having an elongated strip having a first end, a second end and a longitudinal axis there between, in accordance with embodiments of the present invention;

FIG. 2 depicts a plan view of the power or extension handle having an elongated strip having a first end, a second end and a longitudinal axis there between, in accordance with embodiments of the present invention;

FIG. 3-5 depict side cross-sectional views of the power or extension handle having an elongated strip having a first end, a second end and a longitudinal axis there between, in accordance with embodiments of the present invention;

FIG. 6 depicts an elevation view of a power or extension handle having an elongated rod having a first end, a second end and a longitudinal axis there between, and a handle coupled to the rod, in accordance with embodiments of the present invention;

FIG. 7 depicts a side cross-sectional view of the power or extension handle and ratchet wrench, wherein the ratchet handle of the ratchet wrench and the handle operably coupled to the rod are not in the same plane, in accordance with embodiments of the present invention; and

FIG. 8 depicts a flow diagram of a method for using the power or extension handle, in accordance with embodiments of the present invention.

Hereinafter, the term “ratchet” means mechanical gearing used to transmit intermittent rotary motion, permitting a shaft to rotate in one direction, but not in the opposite one. A “wrench” is defined as any of various hand or power tools, often having fixed or adjustable jaws, used for gripping, turning, or twisting objects such as nuts, bolts, or pipes.

Wrenches are helpful in the shop. They are used to tighten and loosen nuts and bolts. There are several types which are advantageously used in embodiments of the power or extension tool of the present invention. The term “wrench” includes the term “pliers” as disclosed herein. The term wrench includes an open-end wrench. This type has a nonadjustable open-end with smooth jaws. They are designed to fit nuts of a specific standard or metric diameter.

The term wrench includes a box-end wrench is also made in standard and metric sizes. The ends of this type of wrench are closed, toothed heads that must be fit over the nut. The head of this type of wrench is often offset.

The term wrench includes adjustable-end wrenches are usually called crescent wrenches. They have smooth jaws that adapt to fit almost any small- to medium-sized nut. The six-, eight-, and ten-inch sizes are the ones most commonly used for stage work.

The term wrench includes the monkey wrench. This is that heavyweight, smooth-jawed, adjustable type of wrench. It is used for large nuts and for work that is just too large for adjustable-end wrenches.

The term wrench includes a pipe wrench is similar in shape to the monkey wrench. This type, however, has serrated jaws to bit into the soft metal of pipes. It is used to hold or twist pipes and their associated couplings.

The term wrench includes socket sets and ratchet handle. Sockets are cylindrical wrenches used with a ratchet handle. The design of the reversible ratchet handle allows the user to tighten or loosen nuts without removing the socket from the nut. This type is very useful in confined spaces.

### DETAILED DESCRIPTION OF THE EMBODIMENTS

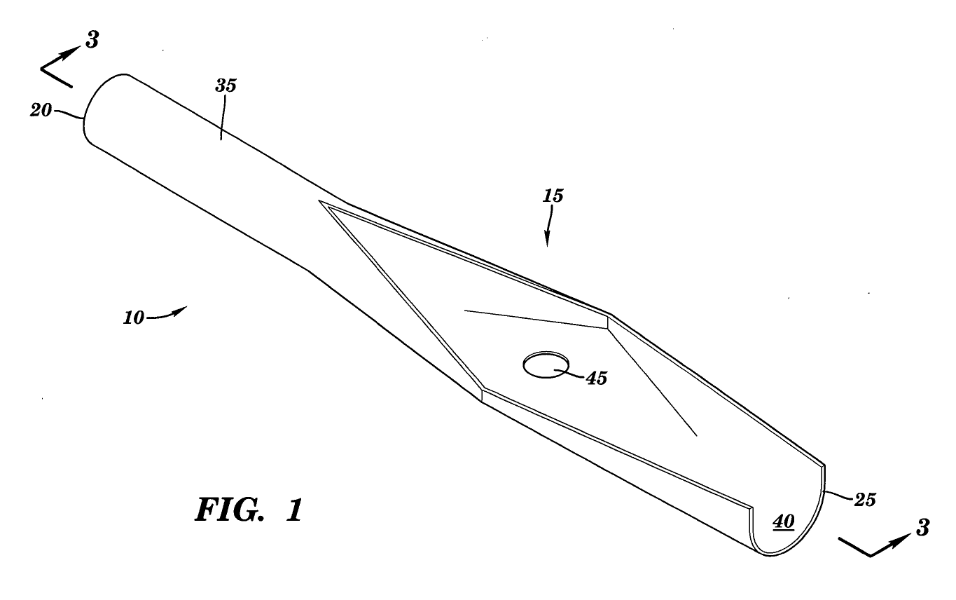

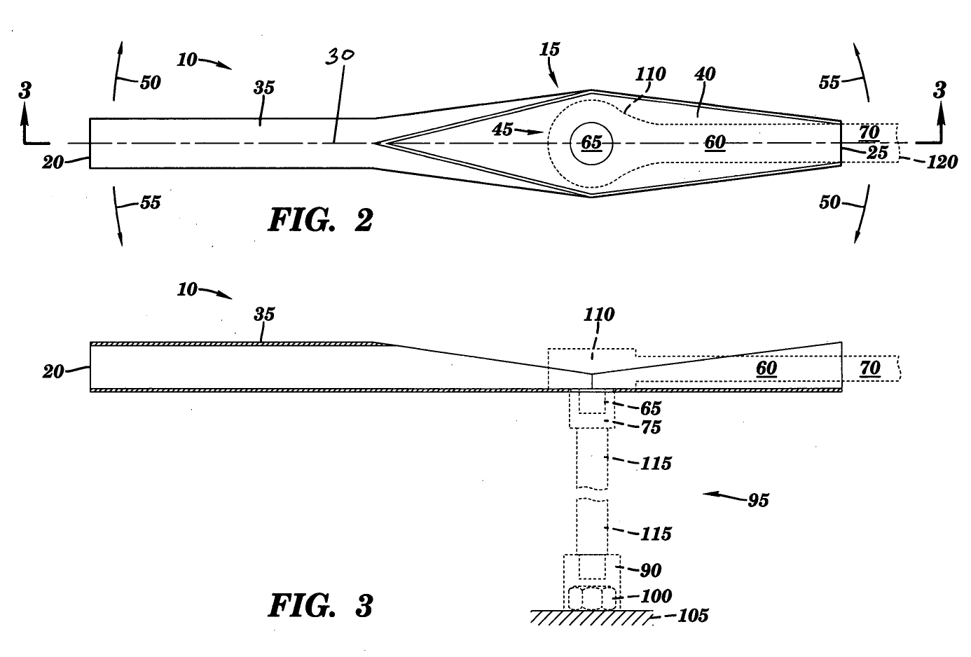

FIGS. 1-5 depict a power or extension handle 10, comprising: an elongated strip 15 having a first end 20, a second end 25 and a longitudinal axis 30, as depicted in FIG. 2 and described in associated text, infra, there between, wherein the first end 20 has a cylindrically shaped handle 35 and the second end 25 has a channeled groove 40, wherein the cylindrically shaped handle 35 and the channeled groove 40 are coplanar with the strip 15 and lie along the longitudinal axis 30 of the strip 15, and wherein the strip 15 has an opening 45 between the handle 35 and the channeled groove 40.

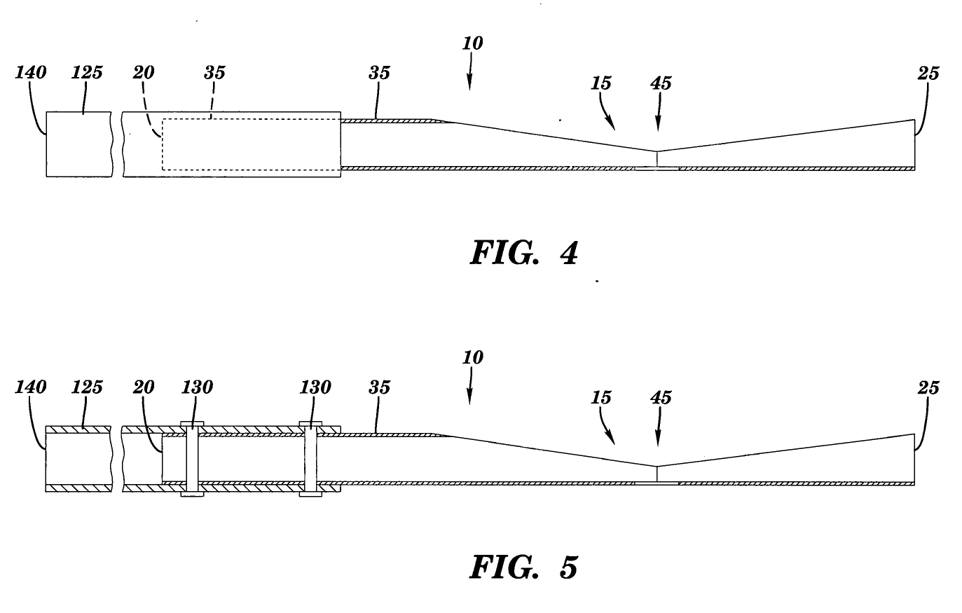

FIG. 2 depicts a top plan view of the power or extension handle 10 in which the channeled groove 40 advantageously has a ratchet wrench 110 inserted into the channeled groove 40, so that the ratchet 65 lies in the opening 45 of the elongated strip 15. The ratchet wrench 110 includes a ratchet 65, a first handle portion 60 in the channeled groove 40 and a remaining handle portion 70 that may extend beyond the end 25 of the elongated strip 15. Alternatively, any wrench such as a crescent, open-end, box-end wrench, or pliers or the like may be inserted into the channeled groove 40 of the power or extension handle 10, so that the portion of the wrench or pliers that grips a nut 100, as depicted in FIG. 3, is aligned with the opening 45 of the strip 15 of the power or extension handle 10, as depicted in FIG. 3 and described in associated text, infra. The power or extension handle 10 that includes a ratchet wrench may be used to tighten the nut 100. The nut 100 may be tightened by a person gripping the cylindrically shaped handle 35 and the portions 60 and 70 of the ratchet wrench 110 and rotating the combination power or extension handle 10 that includes the ratchet wrench 110 inserted into the channeled groove 40 in a clockwise direction. The clockwise tightening of the nut 100 is shown by arrows 50 so that the ratchet wrench 110 may apply a clockwise force to tighten the nut 100, as depicted in FIG. 3 and described in associated text, infra. Alternatively, the power or extension handle 10 that includes ratchet wrench may be used to loosen the nut 100. The nut 100 may be loosened by a person gripping the cylindrically shaped handle 35 and the portions 60 and 70 of the ratchet wrench 110 and rotating the combination power or extension handle 10 that includes the ratchet wrench 110 inserted into the channeled groove 40 in a counter-clockwise direction. The counter-clockwise loosening of the nut 100 is shown by arrows 55 so that the ratchet wrench 110 may apply a counter-clockwise force to loosen the nut 100, as depicted in FIG. 3 and described in associated text, infra.

The power or extension handle 10 is a device for increasing the torque that may be applied to tightening or loosening the nut 100. Hereinafter, torque is defined as the moment of a force; the measure of a force's tendency to produce torsion and rotation about an axis, equal to the vector product of the radius vector from the axis of rotation to the point of application of the force and the force vector. The radius vector of the power or extension handle 10 is a length x₁ from a point at end 20 or a length x₂ from a point at end 120 to a center of the opening 45 of the power or extension handle 10. Torque of the power or extension handle 10 increases in proportion to the lengths x₁ and x₂. Therefore, the torque of a power or extension handle 10 will double if the lengths x₁ and x₂ are doubled. The inventor discloses the torque of the power or extension handle 10 may be increased preferably by a factor from about 1 to about 1,000, depending on the lengths x₁ and x₂ and the tensile strength of the material of construction. The inventor discloses the torque of the power or extension handle 10 may be increased more preferably by a factor from about 1 to about 500, depending on the lengths x₁ and x₂ and the tensile strength of the material of construction. The inventor discloses the torque of the power or extension handle 10 may be increased most preferably by a factor from about 1 to about 50, depending on the lengths x₁ and x₂ and the tensile strength of the material of construction. In addition, the inventor discloses the power or extension handle 10 provides a torque increase over single handle wrenches because the handle 10 doesn't bend as does the handle of the single handle wrench under equivalent applications of force in the range of 100 to 500 lb-ft (pound-feet). This is because the force times the perpendicular distance from the point of application of the force to the axis around which you are applying the force. The power or extension handle 10 may be made of carbon or stainless steel. Alternatively, the power or extension handle 10 may be made of wood or plastic. The wood may be oak or any hard wood. The plastic may be polycarbonate, polyetherimide or acrylonitrile butadiene styrene (abs) plastic and may be reinforced with 10% silica reinforcing filler.

FIG. 3 depicts a side cross-sectional view of the power or extension handle 10 and ratchet wrench 110, advantageously applying either a clockwise tightening force by rotating the nut 100 in a clockwise direction shown by the arrows 50 or a counter-clockwise loosening force by rotating the nut 100 in a counter-clockwise direction shown by the arrows 55 through an inter-connected extension piece 95. Tightening or loosening the nut 100 may advantageously secure the substrate 105 which may be a wall, part of an apparatus or the like. The extension piece 95 includes a standard female fitting 75 adapted to fit a standard ratchet 65, a standard male fitting 90 adapted to fit a standard socket 90 and a connector bar 115. The connector bar may be from about 0.5 inch to about 12 inches in length. The female fitting 75 may include a pivot joint, so that the connector bar 115 may pivot over a 360 degree radius.

FIGS. 4 and 5 depict side cross-sectional views of the power or extension handle 10, wherein the cylindrically shaped handle 35 has been extended by an overlapping sleeve 125, having an extended end 140, so that the cylindrically shaped handle 35 and the overlapping sleeve 125 are a tube within a tube, wherein an outer diameter of the cylindrically shaped handle 35 is less than or equal to an inner diameter of the sleeve 125. The sleeve 125 and the cylindrically shaped handle 35 may be secured with pins 130 that pass through the sleeve 125 and the outer edge of the cylindrically shaped handle 35. The extended length from end 20 to end 140 increases the perpendicular distance from the center of the opening 45, thus increasing the torque that may be applied by the power or extension handle 10. The overlapping sleeve 125 may be made of the same material as the cylindrically shaped handle 35, the elongated strip 15 and the other components of the power or extension handle 10 including stainless steel, carbon steel, wood, plastic or the like.

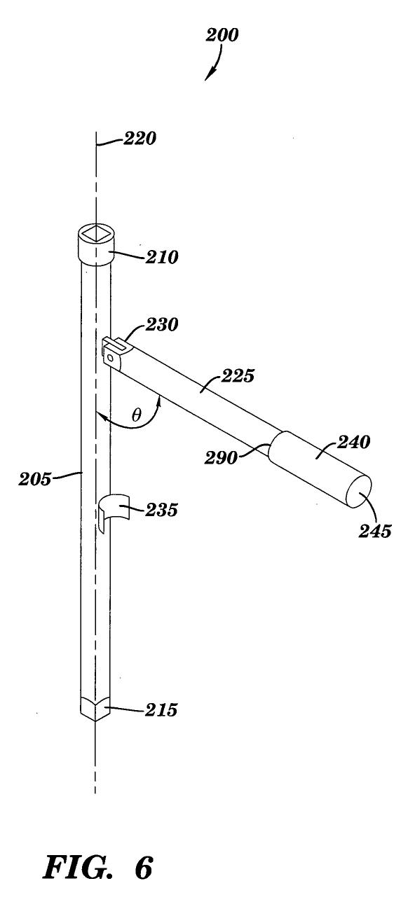

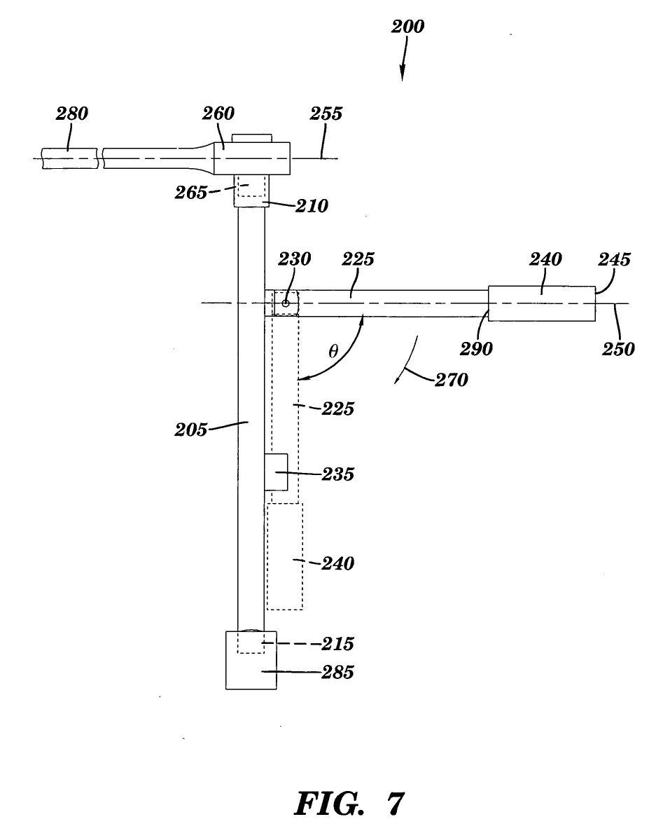

FIG. 6 depicts a front elevation view of a power or extension handle 200, comprising: an elongated rod 205 having a first end 210, a second end 215 and a longitudinal axis 220 there between, wherein the first end 210 is a female fitting for a standard ratchet wrench and the second end 215 is a male end of a standard ratchet wrench; and a handle 225 operably coupled to the elongated rod 205 by physically and directly connecting the handle 225 to the rod 205 to form a non-pivoting joint or union 230, wherein an angle θ formed by the elongated rod 205 and the handle 225 is from about 10 to about 170 degrees. Alternatively, the handle 225 may be operably coupled to the rod 205 via a joint or union 230 so that the handle 225 may pivot in a plane defined by the longitudinal axis 220 and a clasp 235 about the angle θ, wherein θ may be from about 5 to about 175 degrees. Alternatively, the handle 225 may be secured in a rest or unused position by inserting the handle 225 in the clasp 235 by moving the handle 225 in a direction of the arrow 270, as depicted in FIG. 7 and described in associated text infra. The handle 225 may be extended with an overlapping sleeve 240 having an end 245. The components 225, 240, 205, 235, 210 and 215 of the power or extension handle 200 may be made of the same materials as the power or extension handle 10.

FIG. 7 depicts the power or extension handle 200 of FIG. 6, comprising a ratchet wrench 260 having a ratchet 265 and an extendable handle 280. The longitudinal axis 255 of the extendable handle 280 and the longitudinal axis 250 of the handle 225 of the power or extension handle 200 may not be coplanar in the longitudinal direction of the extendable handle 280 and the handle 225. However, they may be in parallel planes or intersecting planes to afford convenience to the user to maximize the torque afforded by the power or extension handle 200, because the handle 225 may be oriented at any angle from about 5 to about 175 degrees around the pivot joint or union 230 along the longitudinal axis 220 of the rod 205.

The power or extension handle 200 is a device for increasing the torque that may be applied to the socket 285. The radius vector of the power or extension handle 200 is a perpendicular length x₁ from a point at end 290 or a perpendicular length x₂ from a point at an end of the ratchet wrench handle 280 to the longitudinal axis 220 of the rod 205 of the power or extension handle 200. Torque of the power or extension handle 10 increases in proportion to the perpendicular lengths x₁ and x₂. The perpendicular length x₂ is extendable to a point 245 at the end of the overlapping sleeve 240 in the same manner as the cylindrically shaped handle 35 was extended using an overlapping sleeve 240. Therefore, the torque of a power or extension handle 200 will double if the lengths x₁ and x₂ are doubled. The inventor discloses the torque of the power or extension handle 200 may be increased preferably by a factor from about 1 to about 1,000, depending on the lengths x₁ and x₂ and the tensile strength of the material of construction. The inventor discloses the torque of the power or extension handle 200 may be increased more preferably by a factor from about 1 to about 500, depending on the lengths x₁ and x₂ and the tensile strength of the material of construction. The inventor discloses the torque of the power or extension handle 200 may be increased most preferably by a factor from about 1 to about 50, depending on the lengths x₁ and x₂ and the tensile strength of the material of construction. In addition, the inventor discloses the power or extension handle 200 provides a torque increase over single handle wrenches because the handle 200 doesn't bend as does the handle of the single handle wrench under equivalent applications of force in the range of 100 to 500 lb-ft (pound-feet). This is because the force times the perpendicular distance from the point of application of the force to the axis around which you are applying the force.

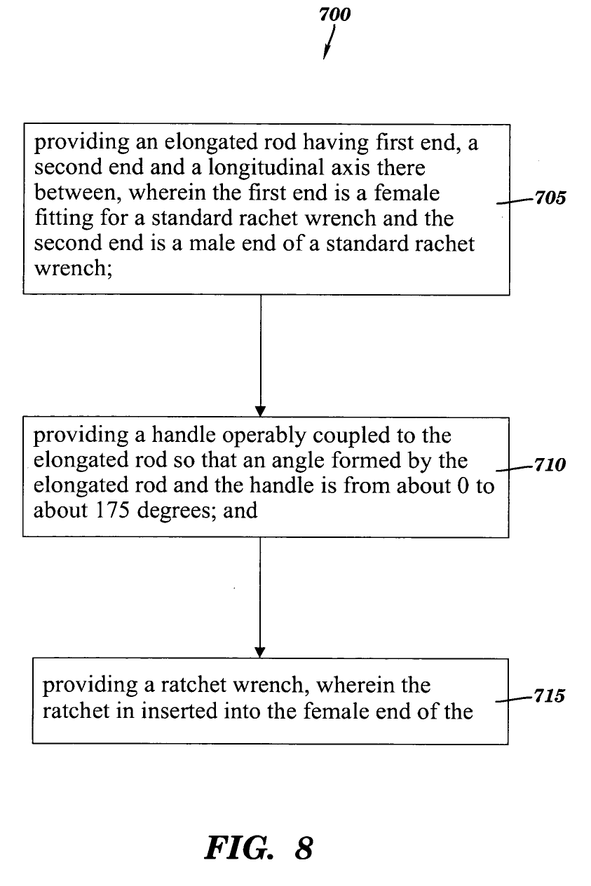

Referring to FIGS. 6 and 7, FIG. 8 depicts a method 700 for using the power or extension handle, comprising: a step 705, providing an elongated rod 205 having first end 210, a second end 215 and a longitudinal axis 220 there between. The first end 210 is a female fitting for a standard ratchet wrench and the second end 215 is a male end of a standard ratchet wrench. The method 700 comprises a step 710, providing a handle 225 operably coupled to the elongated rod 205 so that an angle θ formed by the elongated rod 205 and the handle 215 is from about 5 to about 175 degrees. The method 700 comprises as step 715, providing a ratchet wrench 260, wherein the ratchet 265 in inserted into the female end 210 of the rod 205.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A power or extension handle, comprising:
an elongated strip having a first end, a second end and a longitudinal axis there between,
wherein the first end has a cylindrically shaped handle and the second end has a channeled groove,
wherein the cylindrically shaped handle and the channeled groove are coplanar with the strip and lie along the longitudinal axis of the strip, and
wherein the strip has an opening between the handle and the channeled groove.

2. The handle of claim 1, wherein the channeled groove has a ratchet wrench inserted into the channeled groove, so that the ratchet lies in the opening of the elongated strip of the power or extension handle.

3. The handle of claim 1, wherein the channeled groove has a box-end wrench inserted into the channeled groove, wherein the box-end wrench has a gripping portion, so that the gripping portion is aligned over the opening of the elongated strip of the power or extension handle.

4. The handle of claim 1, wherein a torque may be increased by a factor from about 1 to about 1,000.

5. The handle of claim 1, wherein the material is stainless steel.

6. The handle of claim 1, wherein the material is a plastic.

7. The handle of claim 6, wherein the plastic is polycarbonate.

8. The handle of claim 6, wherein the plastic is polyetherimide.

9. The handle of claim 6, wherein the plastic is acrylonitrile butadiene styrene (abs) plastic.

10. The handle of claim 1, wherein the cylindrical handle has a solid core, wherein the solid core is reinforced plastic selected from the group consisting of reinforced polycarbonate, polyetherimide and acrylonitrile butadiene styrene (abs) plastics.

11. A power or extension handle, comprising:
an elongated rod having a first end, a second end and a longitudinal axis there between,
wherein the first end is a female fitting for a standard ratchet wrench and the second end is a male end of a standard ratchet wrench; and
a handle operably coupled to the elongated rod so that an angle formed by the elongated rod and the handle is from about 0 to about 175 degrees.

12. The handle of claim 11, wherein the rod and handle are made of stainless steel.

13. The handle of claim 11, wherein a torque may be increased by a factor from about 1 to about 1,000.

14. The handle of claim 13, wherein the ratchet handle and the handle operably coupled to the rod are not coplanar.

15. The handle of claim 11, wherein the female fitting is operably coupled to the first end of the rod by a pivot joint.

16. The handle of claim 11, wherein the rod and handle are made of polycarbonate.

17. The handle of claim 11, wherein the rod and handle are made of acrylonitrile butadiene styrene (abs) plastic.

18. The handle of claim 11, wherein the rod and handle are made of polyetherimide.

19. A method of using a power or extension handle, comprising:
providing an elongated rod having first end, a second end and a longitudinal axis there between,
wherein the first end is a female fitting for a standard ratchet wrench and the second end is a male end of a standard ratchet wrench;
providing a handle operably coupled to the elongated rod so that an angle formed by the elongated rod and the handle is from about 0 to about 175 degrees; and
providing a ratchet wrench, wherein the ratchet in inserted into the female end of the rod.

20. The method of claim 18, wherein a torque applied by the ratchet wrench is greater than 1.
